(19) United States
(12) Patent Application Publication
(10) Pub. No.: US 2023/0144441 A1
(43) Pub. Date: May 11, 2023

(54) A BATTERY PACK CELL STATE OF CHARGE BALANCING SYSTEM

(71) Applicant: FUEL CELL TECHNOLOGY SWEDEN AB, Sollentuna (SE)

(72) Inventor: Sebastian WEBER, Malmö (SE)

(21) Appl. No.: 17/928,526

(22) PCT Filed: May 6, 2021
(86) PCT No.: PCT/SE2021/050424

§ 371 Date: Nov. 29, 2022

(30) Foreign Application Priority Data
Jun. 5, 2020 (SE) 2050664-8

(51) Int. Cl. H02J 7/00; H01M 16/00; H02J 7/34; G05F 1/67; H01M 8/04746; H01M 8/04537; H01M 8/04858

(52) U.S. Cl. CPC H02J 7/0019; H01M 16/006; H02J 7/34; G05F 1/67; H01M 8/04753; H01M 8/04619; H01M 8/04947

(57) ABSTRACT

Described herein is a battery pack cell state of charge balancing system (1). A battery pack (2) of the system comprises a plurality of serially connected battery pack cells (BAT1-BATn), each of which (BATx) comprises one or more battery cells connected in parallel. For each respective battery pack cell (BATx) there is a set of serially connected fuel cells (FCx) at battery pack cell voltage level. Each respective set (FCx) is selectively connectable in parallel to a respective corresponding battery pack cell (BATx) by closing a respective first switch (SWx), for charging or boosting battery pack cell (BATx) power output. Each set (FCx) includes a respective DC-DC converter, arranged to regulate the operating point of the set (FCx) to its maximum power point or uniquely selected other operating point, to maintain the respective battery pack cell (BATx) at a defined state of charge for all battery pack cells (BAT1-BATn) constituting the battery pack (2).

### TECHNICAL FIELD

The present disclosure relates generally to a battery pack cell state of charge balancing system.

### BACKGROUND

Battery packs, such as those based on lithium-ion batteries, are used today in a number of applications, such as in electric automotive propulsion systems. Such battery packs usually consist of multiple serially connected battery pack cells. Each respective battery pack cell may comprise one or more battery cells connected in parallel, the plurality of serially connected battery pack cells constituting a battery pack.

Typically, the individual battery pack cells in a battery pack will have somewhat different capacities and may be at different levels of state of charge (SOC). This may be due to manufacturing and assembly variances and differences in charging/discharging and heat exposures histories experienced amongst the battery pack cells.

Due to such differences the smallest capacity battery pack cell may cause problems, as it can be easily overcharged or over-discharged whilst battery pack cells with higher capacities are only partially charged.

Since the battery pack cells are arranged in series, this will result in lower effective capacity, as charging must be stopped when the battery pack cell with the highest voltage reaches its upper voltage limit, and discharging must be stopped when the battery pack cell with the lowest voltage reaches its lower voltage limit.

Thus, this may cause a stop of the battery pack discharging during use when any battery pack cell first runs out of charge, even if the other battery pack cells do not. As a consequence, this will limit the energy that can be taken from and returned to the battery pack.

To overcome this restriction in effective capacity, it is well known that battery pack cells can be “balanced” from time to time. A typical state-of-the-art implementation to balance the battery pack cells of a battery pack is that the charge contained in those battery pack cells having a relatively higher state of charge is dissipated, e.g. via resistive discharge, until all battery pack cells have a common state of charge level that is roughly equal, or “balanced”. This practice, however, due to the dissipation of energy as heat over a resistor, also further reduces the capacity of the battery pack in relation to its theoretically full potential.

There is therefore a need in the art for new and improved ways of balancing battery pack cells, directed at addressing at least some of the current drawbacks in prior art balancing systems.

### SUMMARY

An object of the present invention is to provide an improved a battery pack cell state of charge balancing system.

According to a first aspect this is provided through a battery pack cell state of charge balancing system comprising a plurality of serially connected battery pack cells, each respective battery pack cell comprising one or more battery cells connected in parallel, the plurality of serially connected battery pack cells constituting a battery pack, and for each respective battery pack cell a set of serially connected fuel cells at battery pack cell voltage level, the sets of serially connected fuel cells further being serially connected in correspondence to the plurality of serially connected battery pack cells, wherein each respective set of serially connected fuel cells is selectively connectable in parallel to a respective corresponding battery pack cell by closing a respective first switch, for charging or boosting battery pack cell power output, and each set of serially connected fuel cells includes a respective DC-DC converter arranged to regulate the operating point of the set of serially connected fuel cells to its maximum power point or uniquely selected other operating point to maintain the respective battery pack cell at a defined state of charge for all battery pack cells constituting the battery pack.

The above fuel cell and battery hybrid system allows for state of charge balancing the battery pack cells, whilst maintaining the full electrical potential of a battery pack.

In embodiment herein each respective set of serially connected fuel cells further comprises a power controller arranged to regulate hydrogen and airflow to the fuel cells thereof in relation to optimal power generation and thermal conditions.

In some embodiments the fuel cells in the sets of serially connected fuel cells are open-end Single Proton Exchange Membrane Fuel Cells.

In further embodiments the battery pack cell state of charge balancing system further comprises a switch controller arranged to control the respective first switches to selectively and independently close to connect or open to disconnect each respective set of serially connected fuel cells in parallel to its respective corresponding battery pack cell.

In some of those further embodiments the switch controller is arranged to control the respective first switches to selectively and independently connect each respective set of serially connected fuel cells in parallel to its respective corresponding battery pack cell, for charging or boosting that battery pack cell.

In yet some of those further embodiments the switch controller is arranged to selectively control all of the respective first switches to disconnect all sets of serially connected fuel cells from their corresponding battery pack cells, such that the respective sets of serially connected fuel cells solely are connected in in series with the other sets of serially connected fuel cells, enabling direct fuel cell power output or direct battery pack power output.

In still further embodiments the battery pack cell state of charge balancing system further comprises a selectively operable bypass diode battery pack output enabling selective connection of the plurality of serially connected battery pack cells of the battery pack in parallel with the sets of serially connected fuel cells, for a combined fuel cell and battery pack power output.

In yet some embodiments the respective DC-DC converters comprises a fuel cell power charge controller functionality arranged to regulate the operating point of its respective set of serially connected fuel cells to its maximum power point and, for a constant current charge phase of the battery pack cell, follow the battery pack cell voltage and supply maximum current to the battery pack cell based on the battery pack cell state of charge or load.

In some further embodiments the respective DC-DC converters comprises a fuel cell series enhancer functionality arranged control the output power of its respective set of serially connected fuel cells using a pulse width modulation loop.

In still some of those further embodiments the pulse width modulation loop is arranged to vary the operating point voltage with a predetermined step width to search for the maximum power point or uniquely selected other operating point, and control the output power of its respective set of serially connected fuel cells to maintain the maximum power point or uniquely selected other operating point.

In some additional embodiments each fuel cell in the respective sets of serially connected fuel cells further is equipped with a bypass functionality arranged to provide a current bypass of that respective fuel cell if it is unable to work at the operating point of the other fuel cells in that set.

In still some of those additional embodiments the bypass functionality is arranged to provide for bypass of the fuel cell at a configurable threshold and cancel bypass following another configurable threshold having been reached during a certain configurable time period.

Some of the above embodiments have the beneficial effect of enabling efficient state of charge balancing of the battery pack cells, whilst maintaining the full electrical potential of a battery pack.

Besides allowing for state of charge balancing of the battery pack cells, at least some of the above embodiments enables the series of fuel cells to deliver their collective maximum power into a wide range of load conditions.

Furthermore, at least some of the above embodiments enables elimination of mismatch in the series of fuel cells and thus elimination of potential power loss resulting therefrom.

### BRIEF DESCRIPTION OF DRAWINGS

In the following, embodiments herein will be described in greater detail by way of example only with reference to attached drawings, in which:

FIG. 1 illustrates schematically a battery pack cell state of charge balancing system according to embodiments herein.

FIG. 2 illustrates schematically a first set of serially connected fuel cells providing a charging current to a first battery pack cell whilst supplying an associated load.

FIG. 3 illustrates schematically a first set of serially connected fuel cells supplying an associated load.

FIG. 4 illustrates schematically a first battery pack cell supplying an associated load whilst a current of the first set of serially connected fuel cells is forwarded to bias the next set of serially connected fuel cells and its associated battery pack cell.

FIG. 5 illustrates schematically a battery pack cell state of charge balancing system comprising a selectively operable bypass diode battery pack output.

FIG. 6 illustrates schematically a battery pack cell state of charge balancing system according to FIG. 1 with a Fuel Cell Control system (FCC) and a Battery Management System (BMS) added.

### DESCRIPTION OF EMBODIMENTS

In the following will be described some example embodiments of an improved battery pack cell state of charge balancing system 1.

The herein described battery pack cell state of charge balancing system 1 is based on the realization that fuel cells can provide effective means for facilitating such balancing, whilst maintaining the full electrical potential of a battery pack 2.

Fuels cells have attracted an increased interest as suitable for use in a number of applications recently, such as applications for zero emission automotive solutions intended to shift the result of road vehicle energy usage from CO₂ emissions, to harmless H₂O emissions, i.e. water exhausts.

An advantage of using fuel cells for generating electric motive power, e.g. for road vehicles, is that such road vehicles may use on-board hydrogen storage units, that quickly and easily may be resupplied from a hydrogen refilling station, as compared to the usually rather prolonged charging times of current pure battery electric vehicles.

Thus, the battery pack cell state of charge balancing system 1 proposed herein is a hybrid battery and fuel cell system.

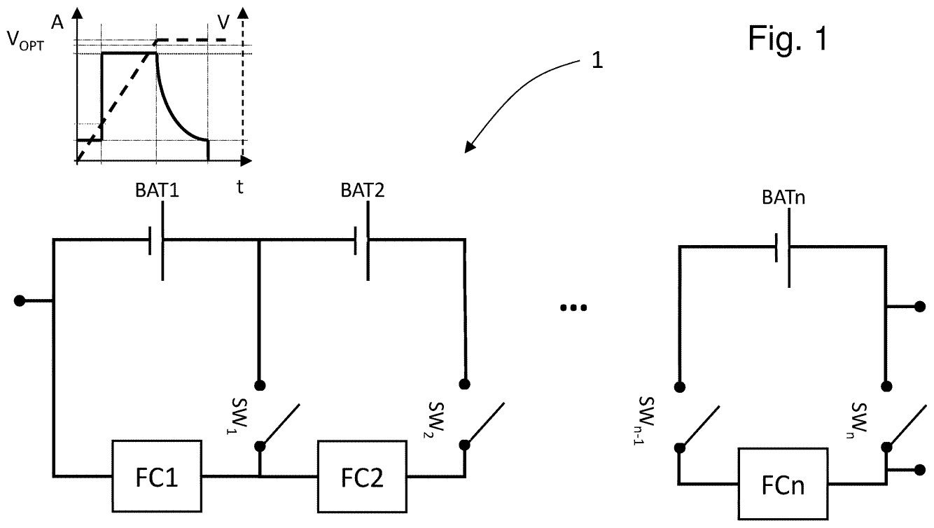

According to a first aspect, as illustrated in FIG. 1, the battery pack cell state of charge balancing system 1 comprises a plurality of serially connected battery pack cells BAT₁-BATₙ. Each respective battery pack cell BAT comprises one or more battery cells (not shown), such as lithium-ion battery cells, connected in parallel. The plurality of serially connected battery pack cells BAT₁-BATₙ constitutes a battery pack 2.

For each respective battery pack cell BAT there is a set of serially connected fuel cells FCₓ at battery pack cell voltage level. The fuel cells in the respective sets FC₁-FCₙ are connected in series to achieve higher potentials, making the sets FC₁-FCₙ easier to control, as will be elucidated in the following.

The sets of serially connected fuel cells FC₁-FCₙ are further serially connected in correspondence to the plurality of serially connected battery pack cells BAT₁-BATₙ, such that there is on set of serially connected fuel cells FCₓ for each of the serially connected battery pack cells BATₓ.

Each respective set of serially connected fuel cells FCₓ is selectively connectable in parallel to a respective corresponding battery pack cell BATₓ by closing a respective first switch SWₓ, for charging or boosting battery pack cell BATₓ power output.

For this purpose, each set of serially connected fuel cells FCₓ includes a respective DC-DC converter (not shown) arranged to regulate the operating point of the set of serially connected fuel cells FCₓ to its maximum power point or uniquely selected other operating point, to maintain the respective battery pack cell BATₓ at a defined state of charge for all battery pack cells BAT₁-BATₙ constituting the battery pack 2.

The above fuel cell and battery hybrid battery pack cell state of charge balancing system 1 thus allows for effective charge balancing, whilst maintaining the full electrical potential of a battery pack 2.

The fuel cell system architecture of the fuel cell and battery hybrid battery pack cell state of charge balancing system 1 described herein suitably encompasses hydrogen and air flow regulation, thermal management, and electrical connection in a symbiotic relationship with a properly sized battery pack 2.

Thus, in some embodiments herein each respective set of serially connected fuel cells FCₓ further comprises a power controller (not shown) arranged to regulate hydrogen and airflow to the fuel cells thereof in relation to optimal power generation and thermal conditions.

The curves of the top-left diagram of FIG. 1 illustrate schematically how a respective set of serially connected fuel cells FCₓ (i.e. one of the sets FC₁ to FCₙ) is regulated to supply its associated battery pack cell BATₓ (i.e. one of the battery pack cells BAT₁-BATₙ). When the battery pack cell BATₓ voltage is lower than an optimal voltage V_{OPT} the associated first switch SWₓ is controlled to be closed and the associated set of serially connected fuel cells FCₓ is regulated to provide a constant charging current (full curve) and an increasing charging voltage (dashed curve) and if the battery pack cell BAT voltage is higher than the optimal voltage V_{OPT} the associated first switch SWₓ is opened, such that the contribution of the associated set of serially connected fuel cells FCₓ is forwarded to support charging of the next battery pack cell having a battery pack cell voltage lower than the optimal voltage V_{OPT}.

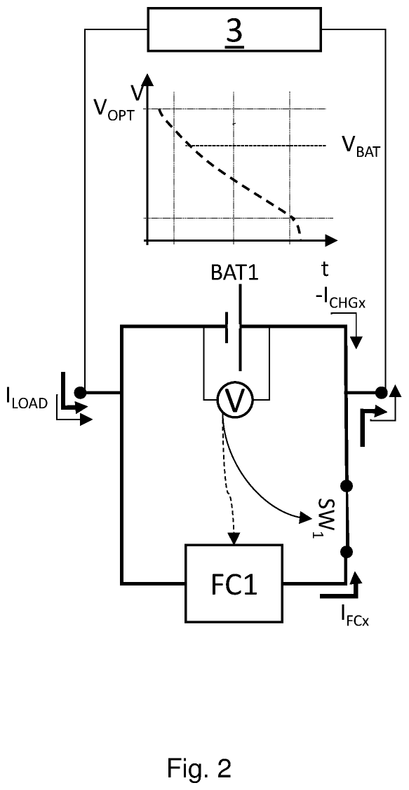

FIG. 2 is a simplified view of the first set of serially connected fuel cells FC₁ when the first switch SW1 is controlled to be closed to provide a charging current I_{CHGx} (dashed curve) to the first battery pack cell BAT₁ whilst at the same time supplying an associated load 3. Charging current illustrated by full curve and charging voltage by dashed curve.

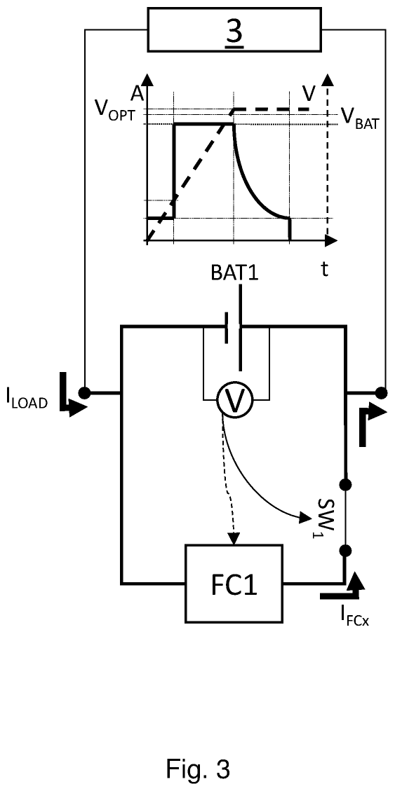

FIG. 3 is a simplified view of the first set of serially connected fuel cells FC₁ in when the first switch SW1 is controlled to be closed to supply an associated load 3 with its full current I_{FCx}, the first battery pack cell BAT₁ being fully charged.

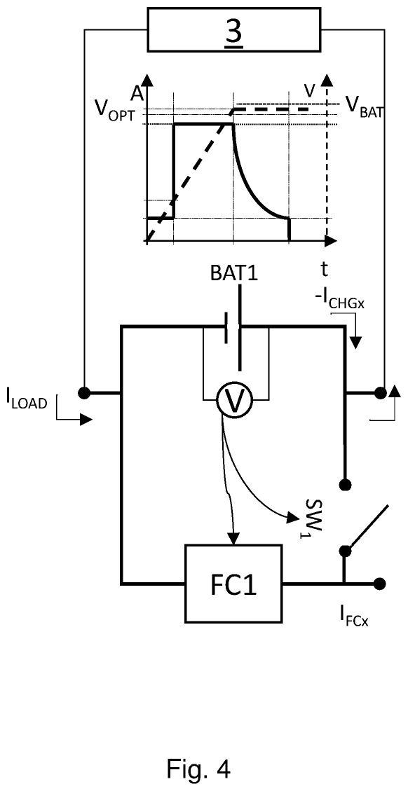

FIG. 4 is a simplified view of the first set of serially connected fuel cells FC₁ in when the first switch SW1 is controlled to be open, and the first battery pack cell BAT₁ supplying an associated load 3 whilst the current I_{FCx} of the first set of serially connected fuel cells FC₁ is forwarded to bias the next set of serially connected fuel cells and its associated battery pack cell. If all the respective voltages of all battery pack cells BAT₁-BATₙ are above the optimal voltage V_{OPT} all fuel cells in the sets of serially connected fuel cells (FC₁-FCₙ) can be turned off.

For the embodiments of the fuel cell and battery hybrid battery pack cell state of charge balancing system 1 described herein it is advantageous if the fuel cells in the sets of serially connected fuel cells FC₁-FCₙ are open-end Single Proton Exchange Membrane Fuel Cells.

Where some prior-art fuel cell systems can be very bulky the use of small, flat and shapeable fuel cells, i.e. micro fuel cells, such as single Proton Exchange Membrane (PEM) fuel cells with an open-end design, e.g. applicants myFC LAMINA™ fuel cells, gives an improved freedom of geometrical design and distributed placement for the fuel cell and battery hybrid battery pack cell state of charge balancing system 1 described herein, providing flexibility in applications, such as applications suitable for automotive vehicles.

The myFC LAMINA™ fuel cells referenced above use hydrogen gas and transform it into clean power. It all starts with a single Proton Exchange Membrane (PEM) fuel cell with an open-end design. Since the myFC LAMINA™ fuel cell design also can use passive air feed and comprise no conventional bi-polar plates, it provides cost advantages and requires a less complicated manufacturing process, as compared to fuel cells comprising conventional bi-polar plates. Thus, using thin, formable, high power density, and low-cost mass producible myFC LAMINA™ fuel cells with an open ended hydrogen system for the fuel cell and battery hybrid system 1 described herein allows for scalable flexibility in configuring and tailoring fuel cell and battery hybrid systems to a multitude of differing applications.

In further embodiments the battery pack cell state of charge balancing system 1 further comprises a switch controller (not shown) arranged to control the respective first switches SWₓ to selectively and independently close to connect or open to disconnect each respective set of serially connected fuel cells FCₓ in parallel to its respective corresponding battery pack cell BATₓ.

In some of those further embodiments the switch controller is arranged to control the respective first switches SWₓ to selectively and independently connect each respective set of serially connected fuel cells FCₓ in parallel to its respective corresponding battery pack cell BATₓ, for charging or boosting that battery pack cell BATₓ.

In yet some of those further embodiments the switch controller is arranged to selectively control all of the respective first switches SW₁-SWₙ to disconnect all sets of serially connected fuel cells FC₁-FCₙ from their corresponding battery pack cells BAT₁-BATₙ, such that the respective sets of serially connected fuel cells FCₓ solely are connected in in series with the other sets of serially connected fuel cells FC₁-FCₙ, enabling direct fuel cell power output or direct battery pack 2 power output.

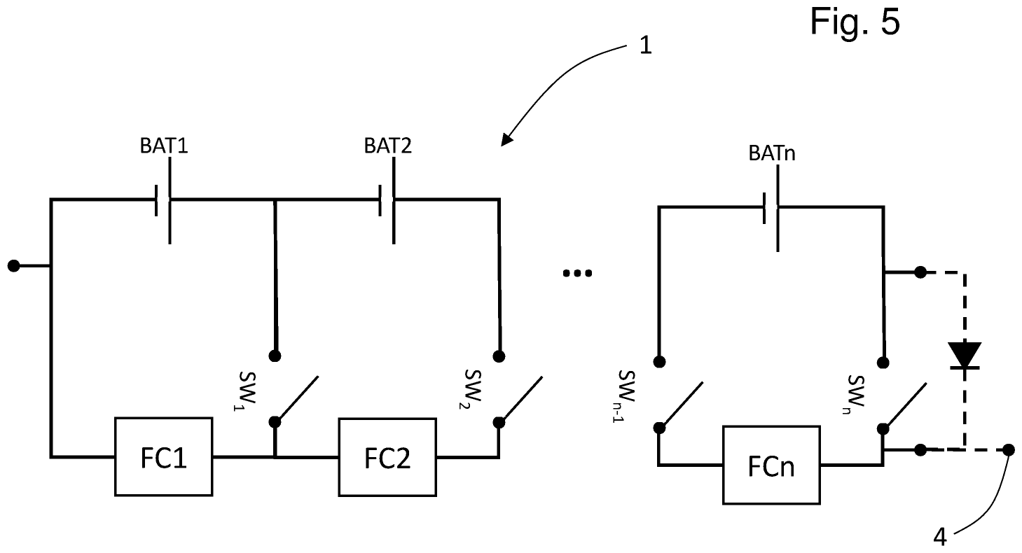

In still further embodiments, as illustrated in FIG. 5, the battery pack cell state of charge balancing system 1 further comprises a selectively operable bypass diode battery pack output 4 enabling selective connection of the plurality of serially connected battery pack cells BAT₁-BATₙ of the battery pack 2 in parallel with the sets of serially connected fuel cells FC₁-FCₙ, for a combined fuel cell and battery pack 2 power output, allowing a higher current output as the accumulated current from the sets of serially connected fuel cells FC₁-FCₙ and the battery pack 2.

In yet some embodiments the respective DC-DC converters comprises a fuel cell power charge controller functionality. This functionality is arranged to regulate the operating point of its respective set of serially connected fuel cells FCₓ to its maximum power point and, for a constant current charge phase of the battery pack cell BATₓ, follow the battery pack cell voltage and supply maximum current to the battery pack cell BATₓ based on the battery pack cell BATₓ state of charge or load.

The heart of fuel cell electrical control is to draw the proper power out of the fuel cell. This is done via the DC-DC converter. In any DC-DC converter design it is vital to, whilst reaching the control targets, still retain a high efficiency. A DC-DC converter generally has greater losses at high currents and at low voltage, exactly what a single fuel cell produces. A single fuel cell has the theoretical working range of slightly above 1 volt down to zero volts, and a current proportional to the physical membrane area and the amount of hydrogen gas supplied and is easily counted in Amps. The low voltage of a single fuel cell does not make it possible achieve high efficiency, this since it is on par with a transistor terminal voltage. For this reason, the serial connection of fuel cells is used to increase the voltage input to the DC-DC converter and by that the efficiency thereof.

Thus, in some further embodiments the respective DC-DC converters comprises a fuel cell series enhancer functionality arranged control the output power of its respective set of serially connected fuel cells FCₓ using a pulse width modulation loop. Series connection of fuel cells creates a sensitivity to cell operational mismatch, resulting in less than optimal power and energy production under real-world conditions. The use of a fuel cell series enhancer functionality enables a series of fuel cells, such as in a respective set of serially connected fuel cells FCₓ, to deliver their collective maximum power into a wide range of load conditions. This enhanced electrical flexibility eliminates power loss from mismatch in the series of fuel cells of the respective sets FCₓ, ultimately improving energy production and system design flexibility.

The fuel cell series enhancers functionality have the further advantages of reducing performance degradation over the fuel cell system operating lifetime, eliminating high power losses, as compared with using a statically selected fuel cell operating point or normal bypass diodes, and facilitates establishing an operating point for limiting the operating voltage and current of the series of fuel cells of the respective sets FCₓ.

In still some of those further embodiments the pulse width modulation loop is arranged to vary the operating point voltage with a predetermined step width, to search for the maximum power point or uniquely selected other operating point, and control the output power of its respective set of serially connected fuel cells FCₓ to maintain the maximum power point or uniquely selected other operating point.

Thus, each respective set of serially connected fuel cells FCₓ is arranged to be controlled by the fuel cell series enhancer functionality to operate electrically independent from other sets of serially connected fuel cells FC₁-FCₙ and at its own unique maximum power point or uniquely selected other operating point, regardless of the operating points of the other sets of serially connected fuel cells FC₁-FCₙ.

In some additional embodiments each fuel cell in the respective sets of serially connected fuel cells FCₓ further is equipped with a bypass functionality arranged to provide a current bypass of that respective fuel cell if it is unable to work at the operating point of the other fuel cells in that set FCₓ. This will remove the power loss impact on the other fuel cells in the series and retain the longevity of the bypassed fuel cell. The preferred bypass functionality is of an active type, that have a minimal forward bias power impact and thus have a minimal power dissipation impact due to the current drawn by the other fuel cells in the series.

In still some of those additional embodiments the bypass functionality is arranged to provide for bypass of the fuel cell at a configurable threshold and cancel bypass following another configurable threshold having been reached during a certain configurable time period.

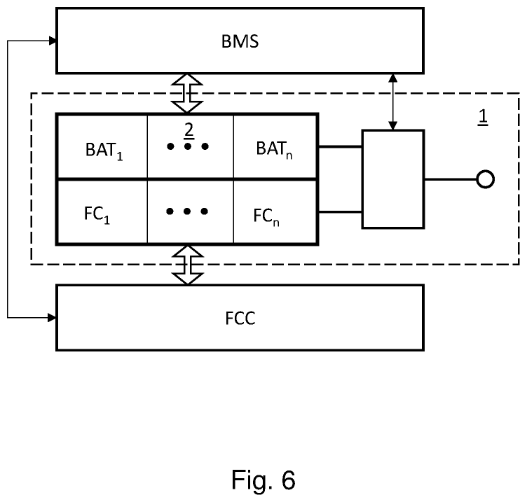

In order to control the fuel cell and battery hybrid battery pack cell state of charge balancing system 1 described herein there should preferably, as illustrated schematically in FIG. 6, be added a Fuel Cell Control system (FCC) and a Battery Management System (BMS). For the fuel cell and battery hybrid battery pack cell state of charge balancing system 1 the FCC is suitably arranged to communicate with the Battery Management System (BMS) to combine the strengths of the fuel cell and battery technologies.

Thus, by combining fuel cells with a battery pack 2, in a battery pack cell state of charge balancing system 1 solution as described above, it is possible to leverage each technology's advantages and balance out their disadvantages, offering the best possible electric performance.

The battery pack cell state of charge balancing system 1, as described above, addresses some of the limitations of fuel cells as well as some of the limitations of batteries, in particular of lithium-ion batteries.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A battery pack cell state of charge balancing system-comprising a plurality of serially connected battery pack cells, each respective battery pack cell comprising one or more battery cells connected in parallel, the plurality of serially connected battery pack cells constituting a battery pack, and for each respective battery pack cell a set of serially connected fuel cells at battery pack cell voltage level, the sets of serially connected fuel cells further being serially connected in correspondence to the plurality of serially connected battery pack cells,
wherein
each respective set of serially connected fuel cells is selectively connectable in parallel to a respective corresponding battery pack cell by closing a respective first switch, for charging or boosting battery pack cell power output, and
each set of serially connected fuel cells includes a respective DC-DC converter arranged to regulate the operating point of the set of serially connected fuel cells to its maximum power point or uniquely selected other operating point to maintain the respective battery pack cell at a defined state of charge for all battery pack cells constituting the battery pack.

2. The battery pack cell state of charge balancing system according to claim 1, wherein each respective set of serially connected fuel cells further comprises a power controller arranged to regulate hydrogen and airflow to the fuel cells thereof in relation to optimal power generation and thermal conditions.

3. The battery pack cell state of charge balancing system according to claim 1, wherein the fuel cells in the sets of serially connected fuel cells are open-end Single Proton Exchange Membrane Fuel Cells.

4. The battery pack cell state of charge balancing system according to claim 1, wherein it further comprises a switch controller arranged to control the respective first switches to selectively and independently close to connect or open to disconnect each respective set of serially connected fuel cells in parallel to its respective corresponding battery pack cell.

5. The battery pack cell state of charge balancing system according to claim 4, wherein the switch controller is arranged to control the respective first switches to selectively and independently connect each respective set of serially connected fuel cells in parallel to its respective corresponding battery pack cell, for charging or boosting that battery pack cell.

6. The battery pack cell state of charge balancing system according to claim 4, wherein the switch controller is arranged to selectively control all of the respective first switches to disconnect all sets of serially connected fuel cells from their corresponding battery pack cells, such that the respective sets of serially connected fuel cells solely are connected in in series with the other sets of serially connected fuel cells, enabling direct fuel cell power output or direct battery pack power output.

7. The battery pack cell state of charge balancing system according to claim 6, wherein it further comprises a selectively operable bypass diode battery pack output enabling selective connection of the plurality of serially connected battery pack cells of the battery pack in parallel with the sets of serially connected fuel cells, for a combined fuel cell and battery pack power output.

8. The battery pack cell state of charge balancing system according to claim 1, wherein the respective DC-DC converters comprises a fuel cell power charge controller functionality arranged to regulate the operating point of its respective set of serially connected fuel cells to its maximum power point and, for a constant current charge phase of the battery pack cell, follow the battery pack cell voltage and supply maximum current to the battery pack cell based on the battery pack cell state of charge or load.

9. The battery pack cell state of charge balancing system according to claim 1, wherein the respective DC-DC converters comprises a fuel cell series enhancer functionality arranged control the output power of its respective set of serially connected fuel cells using a pulse width modulation loop.

10. The battery pack cell state of charge balancing system according to claim 9, wherein the pulse width modulation loop is arranged to vary the operating point voltage with a predetermined step width to search for the maximum power point or uniquely selected other operating point, and control the output power of its respective set of serially connected fuel cells to maintain the maximum power point or uniquely selected other operating point.

11. The battery pack cell state of charge balancing system according to claim 1, wherein each fuel cell in the respective sets of serially connected fuel cells further is equipped with a bypass functionality arranged to provide a current bypass of that respective fuel cell if it is unable to work at the operating point of the other fuel cells in that set.

12. The battery pack cell state of charge balancing system according to claim 11, wherein the bypass functionality is arranged to provide for bypass of the fuel cell at a configurable threshold and cancel bypass following another configurable threshold having been reached during a certain configurable time period.
